(19) United States
(12) Patent Application Publication
(10) Pub. No.: US 2023/0240279 A1
(43) Pub. Date: Aug. 3, 2023

(54) DEVICE FOR CATCHING INSECTS

(71) Applicant: Peter BLOM, Otterup (DK)

(72) Inventor: Peter BLOM, Otterup (DK)

(21) Appl. No.: 17/925,461

(22) PCT Filed: May 7, 2021
(86) PCT No.: PCT/EP2021/062139

§ 371 Date: Nov. 15, 2022

(30) Foreign Application Priority Data
May 15, 2020 (EP) 20174932.2

(51) Int. Cl. A01M 1/14; A01M 1/02

(52) U.S. Cl. CPC A01M 1/14; A01M 1/02; A01M 2200/012

(57) ABSTRACT

The present invention relates to a device and the use of said device for reducing insect irritation of an animal, especially to farm animals such as cattle and horses. Thereby addressing the recurrent problem of insect caused irritation to the eyes and face of an animal as well as to wounds on the surface of an animal or other moist areas offering a source of nourishment to the insects. A device according to the present invention can be directly attached to the surface of an animal in a detachable manner. The device may thus be positioned directly on the animal in a position of choice to the caretaker, thereby, local limitation of the number of insects, such as flies, may be achieved, protecting the animal from insect irritation, particularly in the vicinity of said device, independently of the environment surrounding the animal. Furthermore, it was surprisingly found, that a transparent device provided increased efficiency in catching insects, in particular flies, when attached to an animal compared to a comparable device not being transparent.

### FIELD OF THE INVENTION

The present invention relates to a device for catching insects, such as flies. More specifically, the present invention relates to a device that can be attached in areas where insects are unwanted, such as in the vicinity of a horse eye, or a wound.

### BACKGROUND OF THE INVENTION

Flies and mosquitos and other insects are a common source of irritation to animals such as horses. Irritation caused by insects often occurs around the eyes. Beyond causing annoyance to an animal, the presence of insects around an animal's eyes can be a cause of eye infection. Eye infections compromise the health of an animal's eyes and in severe cases blindness can occur. The presence of insects, in particular flies, also often occurs around a wound on the animal and are a source of irritation to animals as well as a problem for the healing of wounds to the surface of the animal, such as the skin, increasing the risk of infections and disturb the healing process. Furthermore, it is well known that the egg production and thus the reproduction of insects, and in particular flies, increases significantly when protein nutrients are available. Since the concentration of proteins in eye liquid is high there is a need to provide means to overcome the problems associated with especially flies when they have easy access to the eye region as well as wounds to the surface of the animal.

Extensive work in the field has focused on the composition of the attractants used to attract the insects to the devices for catching and/or killing the insects, such as flypaper. Further work has focused on the coloring of insect catching devices, with the aim to increase the efficiency of these devices in attracting insects of different types, such as different fly species. Different insects are found to be attracted to different color wavelengths and graphical patterns. All of these devices are placed in the environment in which a limitation of the number of insects is wanted and thereby provide a general limitation of the number of insects in such environments.

It is an object of the present invention to provide a device for catching insects, such as flies, which can limit the number of insects in the surroundings of a specific animal, such as horses and cattle and/or in a specific area of an animal such as around the eyes of the animal or wounds on the animal.

### SUMMARY OF THE INVENTION

The present invention relates to a device and the use of said device for reducing insect irritation of an animal, especially to farm animals such as cattle and horses. Thereby addressing the recurrent problem of insect caused irritation to the eyes and face of an animal as well as to wounds on the surface of an animal or other moist areas offering a source of nourishment to the insects. The present invention provides a device for catching insects, such as flies, comprising a sheet comprising a first surface with a first adhesive layer and a second surface with a second adhesive layer, said first and said second surfaces being arranged on opposite sides of said sheet, wherein, said first adhesive layer is configured to attach detachably to the surface of an animal and said second adhesive layer is configured for catching and holding insects contacting said second adhesive layer and wherein, said device comprises a part of said device being transparent, said transparent part being arranged within an area of said sheet wherein said sheet comprises said second adhesive layer.

A device according to the present invention can be directly attached to the surface of an animal in a detachable manner. The device may thus be positioned directly on the animal in a position of choice determined by the caretaker, thereby, local limitation of the number of insects, such as flies, may be achieved, protecting the animal from insect irritation, particularly in the vicinity of said device, independently of the environment surrounding the animal. Furthermore, it was surprisingly found, that a transparent device provided increased efficiency in catching insects, in particular flies, compared to a comparable device not being transparent, in particular, when the device was attached to an animal in the vicinity of an area attracting insects, in particular flies, i.e. 30 cm or less from such area. As an example, the device may be positioned 30 cm or less from the eye, such as 15 cm or less from the eye, preferably 10 cm or less from the eye and most preferred 5 cm from the eye. In another example, the device may be positioned in the vicinity of an open wound, i.e. within 30 cm of the wound, such as within 15 cm of the wound, preferably within 10 cm of the wound and most preferred 5 cm from the wound. In another example, the device may be positioned at the lower part of the leg of an animal, such as in the area between the hoof and the knee of a horse.

In one embodiment, said transparent part form the part of said device comprising said second adhesive layer. Preferably, said device is transparent.

In one embodiment, said sheet is made from polypropylene, preferably biaxially oriented polypropylene.

In one embodiment, said sheet has a thickness equal to or less than 0.15 mm, preferably said sheet has a thickness of 0.04 mm.

In one embodiment, said first adhesive layer is further configured to detach from said surface of an animal without damaging said surface, such as the hair of a horse.

In one embodiment, said second adhesive layer further comprises an attractant.

In one embodiment, said second adhesive layer further comprises an insecticide.

In one embodiment, said device further comprises an area having a surface free from any of said first adhesive layer and said second adhesive layer.

In one embodiment, said animal belongs to the group of livestock, farm animals, domestic animal or pets. Preferably, said animal is a horse.

In one embodiment, said device is detachably attached directly to the surface on an animal in any area of said surface available, so to limit the number of flies contacting said animal by attracting the insects to the device.

In one embodiment, said device is detachably attached directly to the surface on an animal, so to limit the number of insects contacting the animal in moist areas on the surface of said animal, such as the area of the eyes of the animal, wounds on the skin of the animal or udder of the animal especially when producing milk.

### DETAILED DESCRIPTION OF THE INVENTION

The present invention relates to a device and the use of said device for reducing insect irritation of an animal, especially to farm animals such as cattle and horses. Thereby addressing the recurrent problem of insect caused irritation to the eyes and face of an animal as well as to wounds on the surface of an animal or other moist areas offering a source of nourishment to the insects.

A device according to the present invention comprises a sheet comprising a first surface with a first adhesive layer and a second surface with a second adhesive layer, said first and said second surfaces being arranged on opposite sides of said sheet, wherein said first adhesive layer is configured to attach detachably to the surface of an animal and said second adhesive layer is configured for catching and holding insects contacting said second adhesive layer and wherein, said device comprises a part of said device being transparent, said transparent part being arranged within an area of said sheet wherein said sheet comprises said second adhesive layer.

The sheet may in the context of the present invention be made from any suitable material having the potential to form a flexible and transparent sheet of a predetermined thickness. Examples of such material is plastic materials such as polypropylene and polyethylene terephthalate (PET).

The first adhesive layer of a device according to the present invention, preferably comprises a non-drying, tacky adhesive substance, which may be generally similar, for example, to that used on conventional Post-it notes or pressure-sensitive tape. Said adhesive being non-toxic to animals, especially mammals, such as horses.

In the present invention said first adhesive layer is configured to directly attach detachably to the surface of an animal, whereby, said device according to the present invention may be placed at any position on the surface of an animal. The ability to detachably attach at any position on the surface of the animal provides the possibility to limit the number of insects, such as flies, in a targeted area of the surface of the animal and not just in the general surroundings of the animal. Thereby, a device according to the present invention may be used to limit the number of insects, such as flies, contacting e.g. the eyes of an animal, a wound on the surface of an animal, or any other area of the animal of interest to the caretaker of such animal, and thereby limits the risk of infection and discomfort to the animal.

Said detachable attachment should both attach strongly enough, so that said device resists weak pulling forces, such as from wind, while at the same time detach from the surface of an animal in response to pulling forces strong enough to otherwise damage said surface of an animal. Such damage may be pulling of hair resulting in a visible mark on the surface of said animal from the loss of hair.

According to the present invention, said second adhesive preferably comprises a non-drying, tacky adhesive substance, which may be generally similar, for example, to that used on conventional sticky flypaper, or on the tackier types of pressure-sensitive tape. A great deal of work has been done in the field of non-drying sticky coatings, so that suitable material is available for this purpose.

It is preferred that the second adhesive layer comprises an attractant. The attractant may be in the form of a fragrance and/or proteins to attract insects. Moreover, the second adhesive layer may comprise an insecticide for killing insects becoming affixed to the adhesive. A great deal of work has been done in the field of attractants and insecticides for catching insects, so that suitable candidates are available for this purpose.

A device according to the present invention may have any suitable thickness that will allow the device to be transparent and flexible so to adapt to the structure of the surface of the animal when attached thereto while strong enough for withstanding the mechanical stress applied to the device during use. Preferably, the thickness of the device is equal to or less than 0.15 mm such as equal to or less than 0,125 mm, more preferably the thickness of the device is equal to or less than 0.1 mm yet more preferably equal to or less than 0.08 mm and most preferably the thickness of the device is equal to 0.04 mm.

A device according to the present invention may have any suitable form and size. The most suitable form and size of the device will depend on the animal on which the device is to be attached and in which position on that animal the device is to be attached. Thus, a device according to the present invention for use on horses may be formed as a rectangle, a ring or any other suitable form. An example may be a rectangle being 5 cm on one side and 15 cm on the other side, or 8 cm on one side and 8 cm on the other side, or 5 cm on one side and 58 cm on the other side, or 7.5 cm on one side and 58 cm on the other. Alternatively, a device according to the present invention may be formed as a sheet from which suitable pieces can be cut prior to use, such sheet may be in the form of a long strip from which smaller pieces may be easily cut prior to use.

A device according to the present invention may be packaged in any suitable packaging, such as a roll, sheets of a predetermined size or of various sizes. The first adhesive layer may optionally be covered by a protective sheet preventing said first adhesive layer from drying and from sticking to any unwanted objects and thereby making said device easier to handle. The second adhesive layer may also optionally be covered by a protective sheet preventing said second adhesive layer from drying and from sticking to any unwanted objects and thereby making said device according to the invention easier to handle. The skilled person will know how to package sheets having an adhesive surface so to protect said adhesive layer from drying and preventing said adhesive layer from catching dust or attach to any unintended objects during transport and storage of said device.

A device according to the present invention preferably comprises an area having a surface free from any of said first adhesive layer and said second adhesive layer. Such an area will make the device easier to handle both when attaching said device on an animal and detaching said device from an animal, such as a horse. Said area may have any suitable shape, such as the shape of a handle, or the periphery of said device, or part of the periphery of said device, such as the outermost area of at least one side of a rectangle. The size of the area having a surface free from any of said first adhesive layer and said second adhesive layer should be large enough to provide sufficient grip to attach said device on an animal and detach said device from an animal, such as a horse, and small enough relative to the total size of the device so that pulling forces such as wind may not detach the device from the surface on an animal. The effect of the pulling force on the device will in part depend on the stiffness of the device. A flexible device may bend due to the force applied by the wind, which will reduce the pulling effect of the wind on the device. Thus, a device according to the present invention may comprise an area having the first and the second surface free from the first and the second adhesive layer respectively of at least 0.5 cm² so to allow sufficient grip by the handler of the device e.g. an animal caretaker.

In one embodiment, a device according to the present invention, having a rectangular shape, with one side having the length of 7.5 cm and the other side having the length of 15 cm, a suitable size of an area having a surface free from adhesive material may be the outermost 5 mm to 10 mm along the length of the rectangle on one side or both.

A device according to the present invention preferably comprises a transparent part arranged within an area of said sheet wherein said sheet comprises said second adhesive layer, more preferably, said transparent part form the part of said device comprising said second adhesive layer, most preferably said device is transparent.

The present invention surprisingly showed an increased efficiency of attracting and catching insects, such as flies, when attached to an animal, in particular a horse, and at least part of said device, comprising a surface with said second adhesive layer, was transparent. An even higher efficiency of attracting and catching insects, such as flies, was obtained when all of said device was transparent and said device was attached to an animal, such as a horse. Said relative efficiency may be measured by comparing at least two devices for catching insects, such as flies, and observing the time from attaching said devices to an animal and until the first fly contacts said devices. A shorter timespan was observed for a transparent device than what was observed for an otherwise comparable but opaque device. Furthermore, said transparent device had a higher capacity measured by the number of flies relative to the size of the area of the device suitable for catching the insects, such as flies.

A transparent device according to the present invention further provides the advantage of being more discrete than a comparable device being opaque and other devices for reducing insect irritation of an animal having an opaque appearance.

An advantage with the present invention is that a device according to the present invention may be attached to the animal in any position of choice in a detachable manner. Thereby, insects, in particular flies, are lured away from said area and caught by the device and subsequently killed directly or indirectly from sticking to the device and thus, effectively limiting the number of flies in the surroundings of the animal. Thus, a device according to the present invention may be attached in the vicinity of the eyes of a horse so that the insects, e.g. flies are lured away from the eyes and caught by the device. A device according to the present invention may be attached next to a wound in order to lure the insects, in particular flies, away from the wound and onto the device where the insects are caught and killed so to effectively limit the number of flies contacting the wound and the number of flies in the surroundings of the animal. A device according to the present invention may be attached in the vicinity of the udder of e.g. a horse producing milk to lure the insects, in particular flies, away from the udder and onto the device where the insects are caught and killed so to effectively limit the number of flies contacting the udder causing irritation to the horse and the number of flies in the surroundings of the animal.

In one embodiment, the device may be positioned 30 cm or less from the eye, such as 15 cm or less from the eye, preferably 10 cm or less from the eye and most preferred 5 cm from the eye.

In one embodiment, the device may be positioned in the vicinity of an open wound, i.e. within 30 cm of the wound, such as within 15 cm of the wound, preferably within 10 cm of the wound and most preferred 5 cm from the wound.

In one embodiment, the device may be positioned in the vicinity of the udder of a lactating animal, such as a horse, i.e. within 30 cm of the udder, such as within 15 cm of the udder, preferably within 10 cm of the udder and most preferred 5 cm from the udder.

In one embodiment, the device may be positioned at the lower part of the leg of an animal, such as in the area between the hoof and the knee of a horse.

A device according to the invention may be attached to any animal, such as animals belonging to the group of livestock animals, farm animals, domestic animals or pets. Said device being particularly useful for use on animals suffering from irritation and discomfort caused by insects, such as flies. A device according to the present invention is preferably used to reduce insect irritation of farm animals, more preferably a device according to the present invention is used to reduce insect irritation of cattle and horses, most preferably a device according to the present invention is used to reduce insect irritation of horses.

### Examples

Use of a Device for Catching Insects According to the Present Invention

The object of the following tests was to evaluate the efficiency of a device according to the present invention for catching flies when the device was placed on a horse. The tests were performed using a device according to the present invention in the form of a flexible transparent sheet made of biaxially oriented polypropylene (BOPP) having a thickness of 0.04 mm and having a width of 7.5 cm and being 10 cm in length. The flexible transparent sheet had an adhesive layer on both sides arranged so to leave an adhesive free area of 0.5 cm on the outermost part of the width of the sheet. The devices which were compared in the following tests, were cut so to have equal length and thus equal size.

The tests were performed by placing the device on the horse, more specifically on the head of the horse, 5 cm from an eye, on the flank of the horse, on the neck of the horse and on a reference site such as a sunlit wall or other object in the test environment next to the horse.

Flies are attracted by heat, pus and fluid from a wound, fluid from the eyes and milk from the udder of a lactating horse, thus the primary test areas were in the vicinity of those attracting areas where the flies are causing most harm and discomfort to the animal. In addition, it is observed that flies also are attracted to the lower part of the leg of a horse.

The primary test areas were therefore the jaw of the horse in the vicinity of the eye, specifically the device was placed 5 cm from the eye. Other primary test areas may be in the vicinity of an open wound, preferably 5 cm from the wound, or on the lower part of the leg in the area below the knee and above the hoof.

A number of reference areas on the horse were also included in the test, one reference device was placed on the shoulder of the horse and one on the flank of the horse, both areas in which no natural attractants occur except for the body heat.

Each test was performed over the period of 30 min, in which the number of flies attached to the device was noted after 1 min, 5 min, 15 min and 30 min.

During the tests, the horses were placed outdoor in the environment of a pen or stable on sunny days. The test sites were chosen due to the high activity of flies in the environment and especially in the heat from the sun.

Test A: Effect of the Visual Appearance of the Device

The test was performed using a transparent device as described above compared with a comparable non-transparent device in yellow and a comparable non-transparent device in white. All three devices were placed on the jaw of the horse 5 cm from one eye. A transparent device was also placed at a wall, on the neck of the horse and on the flank of the horse. The number of flies attached to each device were counted after 1 minute, 5 minutes, 15 minutes and 30 minutes. The results are represented in table 1.

TABLE 1
Number of flies caught by each device

| Minutes | Transparent | yelow | white | wall | neck | flank |
|---|---|---|---|---|---|---|
| 1 | 8 | 0 | 1 | 0 | 0 | 0 |
| 5 | 48 | 5 | 11 | 0 | 1 | 0 |
| 15 | 165 | 21 | 33 | 0 | 1 | 1 |
| 30 | 325 | 44 | 67 | 0 | 2 | 2 |

As can be appreciated from table 1, the transparent device (column “transparent”) which was placed 5 cm from one eye of the horse was surprisingly efficient in catching flies. The transparent device was fully occupied with flies before the expiry of 30 minutes and it is therefore expected, that the final number of flies would have been higher if there had been room for more flies.

Test B: Effect of the Color of the Horse on the Efficiency of a Transparent Device

The test was performed using a transparent device as described above. One device was placed on each of the primary test areas as well as the reference areas on a white horse, a black horse and a brown horse as well as a wall next to the horses. The number of flies attached to each device were counted after 1 minute, 5 minutes, 15 minutes and 30 minutes.

The number of flies caught during the test were comparable with the result for the transparent device in test A and the color of the horse showed no effect on the efficiency of the device for catching flies.

Test C: Effect of the Color of the Horse on the Efficiency of a Transparent Device and Colored Devices.

The test was performed using the same setup as in test A on a white horse, a black horse and a brown horse.

The number of flies caught during the test were comparable with the result for the transparent device in test A. The color of the horse had no effect on the efficiency of any of the devices in catching flies and it was thus observed that the color combination between the color of the horse and the white and yellow device had no effect on the efficiency of the devices in catching of flies.

Test D: Effect of Attractants on the Efficiency of a Transparent Device

The test was performed using a transparent device as described above. An attractant was added to the adhesive layer configured for catching and holding insects. Four devices were prepared, one without an attractant, one with fruit, one with chocolate and one with sex hormone (Muscalure).

All four devices were placed on the jaw of the horse 5 cm from one eye. Transparent devices without and with attractants were also placed on a wall, on the neck of the horse and on the flank of the horse. The number of flies attached to each device were counted after 1 minute, 5 minutes, 15 minutes and 30 minutes.

All the four test devices showed comparable efficiency with the efficiency of the transparent device in test A. All the test devices placed at reference sites showed similar efficiency as the reference devices in test A. No significant difference was observed between the different test devices, and it was concluded that the addition of an attractant had no effect on the efficiency of the device.

Test E: Effect of the Thickness of the Device on the Efficiency of a Transparent Device

The test was performed using a transparent device as described above i.e. a flexible transparent sheet made of biaxially oriented polypropylene (BOPP) having a thickness of 0.04 mm and having a width of 7.5 cm and being 10 cm in length. The flexible transparent sheet had an adhesive layer on both sides arranged so to leave an adhesive free area of 1 cm on the outermost part of the width of the sheet. This device was compared with a second transparent device in the form of a flexible transparent sheet made of polyethylene terephthalate (PET) having a thickness of 0,125 mm and having a width of 7.5 cm and being 10 cm in length. The flexible transparent sheet had an adhesive layer on both sides arranged so to leave an adhesive free area of 0.5 cm on the outermost part of the width of the sheet. The two devices were cut so to have equal length and thus equal size.

Both devices were placed on the jaw of the horse 5 cm from one eye, at a wall, on the neck of the horse and on the flank of the horse. The number of flies attached to each device were counted after 1 minute, 5 minutes, 15 minutes and 30 minutes.

The first device having a thickness of 0.04 mm showed comparable results as the transparent device in test A, while the second device having a thickness of 0,125 mm caught approximately half the number of flies compared with the first device.

It was furthermore observed that the first device attached to the horse in a more smoothly manner, following curves and structures on the surface of the horse more closely than the second device. In addition, it was observed that the second device had a higher tendency than the first device to flicker in the wind or when the horse move e.g. by shaking the head or body. Thus, the first device could be placed in any position on the horse without risking vigorous flickering of the device in the wind and potential detachment of the device. It is speculated, that the increased flickering of the second device compared to the first device deterred the flies from landing on the second device and thereby reduced the efficiency of the device in catching flies.

The adhesive free area in the periphery of the devices provides an area, which is suitable for handling the device during unpacking from any protective layers and for placing the device on the horse and for detaching the device after use on a horse. The adhesive free area should be at least 5 mm wide, such as 8 mm or 1 cm for allowing a human to hold the device without being in contact with the adhesive part of the device. The adhesive free area is especially prone to move in the wind. It was observed that the adhesive free area of the first device would simply bend to the wind without causing disturbance to the rest of the device when placed on a horse. In comparison, it was observed that the adhesive free area of the second device had a tendency to flicker in the wind and cause movement of the entire device when placed on the horse.

1. A method for catching insects, such as flies, said method comprising step of detachably attach a device to a surface of an animal, said device comprising:
a sheet comprising:
a first surface with a first adhesive layer and
a second surface with a second adhesive layer
said first and said second surfaces being arranged on opposite sides of said sheet, wherein,
said first adhesive layer is configured to attach detachably to the surface of an animal and said second adhesive layer is configured for catching and holding insects contacting said second adhesive layer and wherein,
said device comprises a part of said device being transparent, said transparent part being arranged within an area of said sheet wherein said sheet comprises said second adhesive layer.

2. The method according to claim 1, wherein said transparent part form the part of said device comprising said second adhesive layer.

3. The method according to claim 1 wherein said device is transparent.

4. The method according to claim 1, wherein said sheet is made from polypropylene.

5. The method according to claim 1, wherein said sheet is made from biaxially oriented polypropylene.

6. The method according to claim 1, wherein said sheet has a thickness equal to or less than 0.15 mm.

7. The method according to claim 1, wherein said sheet has a thickness of 0.04 mm.

8. The method according to claim 1, wherein said first adhesive layer is further configured to detach from said surface of an animal without damaging said surface.

9. The method according to claim 1, wherein said surface of an animal is the hair of a horse.

10. The method according to claim 1, wherein said second adhesive layer further comprises an attractant.

11. The method according to claim 1, wherein said second adhesive layer further comprises an insecticide.

12. The method according to claim 1, wherein said device further comprises an area having a surface free from any of said first adhesive layer and said second adhesive layer.

13. The method according to claim 1, wherein said animal belongs to the group of livestock, farm animals, domestic animal or pets.

14. The method according to claim 1, wherein said animal is a horse.

15. The method according to claim 1, wherein said device is detachably attached directly to the surface on an animal, so to limit the number of insects contacting the animal in moist areas on the surface of said animal, such as the area of the eyes of the animal, wounds on the skin of the animal or udder of the animal especially when producing milk.
